(19) United States
(12) Patent Application Publication
(10) Pub. No.: US 2017/0103125 A1
(43) Pub. Date: Apr. 13, 2017

(54) APPARATUS AND METHOD OF EXPLORING AND ACCESSING RELEVANT DATA FROM BIG DATA REPOSITORY

(71) Applicant: Samsung Electronics Co., Ltd., Suwon-si (KR)

(72) Inventors: Brahmananda SAPKOTA, Seoul (KR); Gook-pil ROH, Bucheon-si (KR)

(21) Appl. No.: 15/286,051

(22) Filed: Oct. 5, 2016

(30) Foreign Application Priority Data
Oct. 8, 2015 (KR) 10-2015-0141533

(51) Int. Cl. G06F 17/30

(52) U.S. Cl. CPC G06F 17/30734; G06F 17/30705; G06F 17/30619

(57) ABSTRACT

A server device is provided. The server device includes a communicator configured to receive a query request from an external electronic device, a storage configured to store information related with the query, and at least one processor configured to search for relation information related with the query of the query request based on the query request within an ontology which is generated by using data stored in a database, automatically select at least one keyword in the relation information list, and control the communicator to transmit the selected at least one keyword to the external electronic device.

### CROSS-REFERENCE TO RELATED APPLICATION(S)

This application claims the benefit under 35 U.S.C. §119(a) of a Korean patent application filed on Oct. 8, 2015 in the Korean Intellectual Property Office and assigned Serial number 10-2015-0141533, the entire disclosure of which is hereby incorporated by reference.

### TECHNICAL FIELD

The present disclosure relates to an apparatus and a method of exploring and accessing relevant data from big data repository. More particularly, the present disclosure relates to a server device, an external electronic device and a control method thereof for providing a method for a user to search and access big data with ease, as the server device analyzes a query request regarding the query request received from the external electronic device, catalogues information related with the query request, and provides the result to the external electronic device.

### BACKGROUND

According to the development of the current information & communication technology (ICT), various fields of industries are converged with one another. Thereby, for example, a size of big data expands because a data amount generated in various equipment such as smart phones and internet of things (IoT). The ‘big data’ indicates enormous data collection in which data is generated at the digital environment and a data size is so enormous that a related method is difficult to collect/store/analyze/manage the data.

In a related art, a method may be provided in which a big data analyst having a professional knowledge in relevant fields accesses big data repository (e.g., data warehouse, and so on), analyzes the data related with the requested data, and provides a result to a user when a user requests the analysis of big data. Herein, the big data repository may store complicated relations between the stored data in numerous list formats. Thereby, because a user having no professional knowledge has a difficulty in understanding relation information of the complicated data, a user may need a support of a professional big data analyst in order to access the big data and search related information.

Thus, when a user accesses and searches the big data with a related method, the efficiency may deteriorate because it takes a time until information is requested to a big data analyst and a result regarding the requested information is obtained. Further, a job amount of a big data analyst increases according to increasing user requests compared to limited resources, the efficiency for a user to access the big data may deteriorate.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a control method thereof in which a data user may request a query to a server device through an electronic apparatus without a support of a data analyst, explore and access big data by being provided with relation information of the query requested information from the server device.

In accordance with an aspect of the present disclosure, a server device is provided. The server device includes a communicator configured to receive a query request from an external electronic device, a storage configured to store information related with a query of the query request, and at least one processor configured to search for relation information related with the query of the query request based on the query request within an ontology which is generated by using data stored in a database, automatically select at least one keyword in the relation information list, and control the communicator to transmit the selected at least one keyword to the external electronic device.

Further, when a related information list request regarding the selected at least one keyword is received from the external electronic device, the at least one processor may search the storage for information related with the selected keyword, categorize the searched information related with the selected keyword, and control the communicator to transmit a result to the external electronic device.

Further, when a related information request regarding one information item among the categorized information is received from the external electronic device, the at least one processor may additionally search the storage for information related with the information item, and control the communicator to transmit the additionally searched information to the external electronic device.

Further, when a result request regarding one information item among the additionally searched information is received from the external electronic device, the at least one processor may extract the information related with the information item in the database, and control the communicator to transmit the extracted related information to the external electronic device.

Further, the ontology may be configured with a plurality of entity nodes having concepts and relation branches connecting the plurality of entity nodes, and the at least one processor may automatically select a concept of at least one of the entity nodes as the keyword when the at least one entity node comprises an entity node lower than remaining entity nodes of the plurality of entity nodes.

Further, the information stored in the at least one processor is further configured to map data in the database into a plurality of entity nodes of the ontology, convert a code value defined when mapping the data within the ontology into general words, and generate the relation information list using the general words.

In accordance with another aspect of the present disclosure, an electronic device is provided. The electronic device includes a communicator configured to receive information related with a query request from a server device, an inputter configured to receive a user command regarding the query request from a user and the information related with the query request received from the server device, a display, and at least one processor configured to control the display to display information related with the query request received from the server device through the communicator.

The at least one processor may control the communicator to transmit the query request to the server device, control the communicator to receive at least one keyword among the information related with a query of the query request from the server device according to the query request, and control the communicator to request a related information list regarding the received at least one keyword to the server device, when an item is selected through the inputter from among the at least one keyword.

The at least one processor may control the communicator to receive the related information list from the server device, control the communicator to request related information regarding an information item among the received related information lists to the server device, and control the communicator to receive a related information result regarding the information item from the server device.

In accordance with another aspect of the present disclosure, a data processing method of a server device is provided. The data processing method includes receiving a query request from an external electronic device, storing relation information related with a query of the query request, searching for relation information related with the query of the query request based on the query request within an ontology which is generated by using data stored in a database, generating a relation information list based on the data included in the ontology, automatically selecting at least one keyword in the relation information list, and transmitting the selected keyword to the external electronic device.

When a related information list request regarding the selected at least one keyword is received from the external electronic device, the method may include searching for information related with the selected at least one keyword, categorizing the searched information, and transmitting a result to the external electronic device.

When a related information request regarding an information item among the categorized information is received from the external electronic device, the method may include additionally searching for information related with the information item, and transmitting the additionally searched information to the external electronic device.

When a result request regarding the information item among the additionally searched information is received from the external electronic device, the method may include extracting information related with the information item in the database, and transmitting the extracted related information to the external electronic device.

The ontology may be constituted with a plurality of entity nodes having concepts and relation branches connecting the plurality of entity nodes, and the transmitting may include automatically selecting a concept of an entity node as the keyword when the entity node comprises an entity node lower than remaining entity nodes of the plurality of entity nodes.

The method further comprises mapping the data stored in the database into a plurality of entity nodes of the ontology, converting a code value defined when mapping the data within the ontology into general words, and generating the relation information list using the general words.

In accordance with another aspect of the present disclosure, a data processing method of an external electronic device for exploring and accessing big data is provided. The data processing method includes receiving information related with a query of a query request in a server device, receiving an inputting of a user command regarding the query request from a user and the information related with the query received from the server device, and controlling a display to display the information related with the query of the query request received from the server device.

The method may further include transmitting the query request to the server device, receiving at least one keyword among the information related with the query from the server device according to the query request, and requesting a related information list regarding the received keyword to the server device.

The method may include receiving the related information list from the server device, requesting information related with an information item among the received related information list to the server device, and receiving a related information result regarding the information item from the server device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a system diagram illustrating the big data exploring according to an embodiment of the present disclosure;

FIG. 2 is a block diagram illustrating constitution of an external electronic device according to an embodiment of the present disclosure;

FIG. 3 is a block diagram illustrating constitution of a server device according to an embodiment of the present disclosure;

FIG. 4 is a diagram illustrating the ontology concept regarding a query request according to an embodiment of the present disclosure;

FIG. 5 is a diagram illustrating the ontology schema structure regarding a query request according to an embodiment of the present disclosure;

FIG. 6 is a diagram explaining the ontology when exploring the schema regarding a query request according to an embodiment of the present disclosure;

FIG. 7 is a diagram explaining a method of exploring regarding a query request within the ontology according to an embodiment of the present disclosure;

FIGS. 8A, 8B, 8C, 8D, 8E, and 8F are diagrams explaining that a schema searching result within the ontology is displayed on an electronic device according to an embodiment of the present disclosure;

FIG. 9 is a flowchart explaining a process of requesting a query to a server device from an electronic device according to an embodiment of the present disclosure;

FIG. 10 is a flowchart explaining a process of exploring and accessing big data regarding a query request received by a server device from an electronic device according to an embodiment of the present disclosure; and

FIG. 11 is a sequence diagram explaining a process of exploring and accessing data from big data engine which is performed by an electronic device and a server device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Further, unless otherwise specified, a singular expression used herein includes a plural expression. The term such as “composed of,” “comprise,” and so on as used herein should not be interpreted as necessarily including several elements or operations described herein, but interpreted as meaning that certain elements or operations thereof may not be included, or certain additional elements or operations may be additionally included.

Further, while a suffix ‘-er(or)’ added after the element used herein is added or mixed solely in consideration of convenience of drafting the description, this does not give any distinguishing meaning or serve to distinguish the element from another.

Further, a term including an ordinal number such as “first,” “second,” and so on may be used in describing a variety of elements, but the element should not be limited by such term. The terms are used solely for the purpose of distinguishing one element from another. For example, without departing from the breadth of the present disclosure, a “first element” may be named a “second element,” or similarly, a “second element” may be named a “first element.”

In the following description, same drawing reference numerals are used for the same elements even in different drawings. The matters defined in the description, such as detailed construction and elements, are provided to assist in a comprehensive understanding of the present disclosure. Accordingly, it is apparent that the various embodiments of the present disclosure can be carried out without those specifically defined matters.

Also, well-known functions or constructions are not described in detail since they would obscure the disclosure with unnecessary detail. Further, the drawings are provided only to facilitate understanding of the spirit of the present disclosure, but note that the spirit of the present disclosure is not limited to the drawings.

Referring to the attached drawings, the various embodiments will be described in detail below.

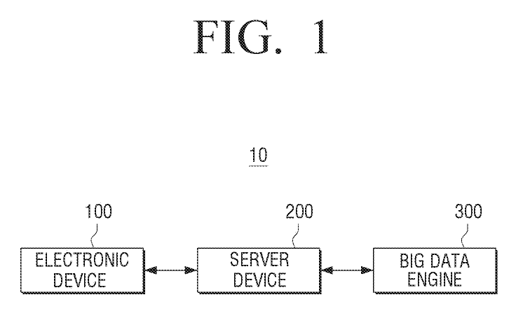

FIG. 1 is a diagram illustrating a big data system constituted for exploring big data according to an embodiment of the present disclosure.

Referring to FIG. 1, a system 10 may include an electronic device 100 requesting a query to be searched to a server device 200, the server device 200 communicating with the electronic device 100 and a big data engine 300, and the big data engine 300 communicating with the server device 200.

Herein, each device constituting the system 10 may perform the communication through a network (not illustrated). The network (not illustrated) may be a local area network (LAN), a wireless network, a mobile communication network, a wide area network (WAN) such as the Internet, or a similar communication system.

According to an embodiment, the electronic device 100 may request necessary data information to the server device 200 by a data user. In the present disclosure, a request for data information of the electronic device 100 may be expressed as a query request. The electronic device may be, for example, a computing device such as tablet computer, lap-top computer, personal digital assistant (PDA), mobile communication devices, portable phone, smart phone, desktop computer, and so on. Further, a user using the electronic device 100 may be a governmental organization, a private organization, a company or a personal user.

According to an embodiment, the server device 200 may receive a query request from the electronic device 100 or may be provided with open type data (not illustrated) through a network (not illustrated) and data from the big data engine 300. Further, the server device 200 may be provided with internal data which is data between internal systems. Herein, the server device 200 may collect, process, store and analyze the provided data, and provide the result to the electronic device 100.

According to an embodiment, specifically, the server device 200 may search and analyze relation information related with a query request of the electronic device 100 from the database stored in the server device 200 and in the big data engine 300, and transmit to the electronic device 100. The server device 200 may be, for example, a server computer, a gateway computer, a desktop computer, a laptop computer, a tablet computer, PDA, a mobile communication device, a portable phone, a smart phone, or a similar computing device.

The big data engine 300 may be a big data repository where mass data are stored. The big data engine 300 may be provided with data from external open type data through the network (not illustrated), or provided with internal data between the internal systems. According to an embodiment, the internal data between the internal systems may be categorical information data provided per representing department of a company.

Further, the big data engine 300 may be database such as big data repository (e.g., data warehouse) storing data provided from a governmental organization, a private organization, a portal business manager, a broadcasting communication business manager, an individual business man, and an individual person who are data providers.

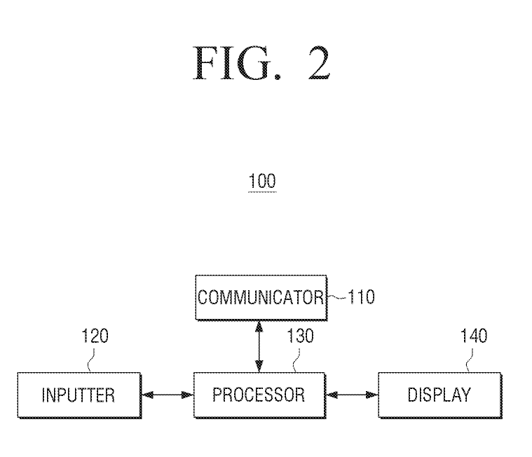

FIG. 2 is a block diagram illustrating constitution of the electronic device 100 according to an embodiment of the present disclosure.

According to an embodiment, referring to FIG. 2, the electronic device 100 may include a communicator 110, an inputter 120, a processor 130 and a display 140. The communicator 110 may request a query regarding necessary data information to the server device 200. Further, the communicator 110 may receive information related with the query request form the server device 200.

The inputter 120 may receive a command regarding a query request from a user. Further, the inputter 120 may receive a command regarding the information related with a query request received from the server device 200. Specifically, the inputter 120 may receive a user command through inputting means such as touch, keyboard, mouse, and stylus pen.

The display 140 may display a relation information result related with a query request received from the server device 200. Herein, the relation information result related with a query request may be displayed as graphical user interface (GUI, e.g., list, graph, index and so on) on a liquid crystal display (LCD) or a cathode-ray tube (CRT).

According to an embodiment, specifically, a user may input a query request through inputting means such as keyboard and touch to the electronic device 100. The server device 200 may display a relation information list regarding a query request inputted from the electronic device 100 through the user interface on the electronic device 100. A user may select the relation information list displayed on the electronic device 100 through inputting means such as touch, keyboard, mouse, and stylus pen. Herein, the inputter 120 may receive the inputting of a command regarding the list selected by a user.

The processor 130 may control the display 140 to display the information related with a query request received from the server device 200 through the communicator 110. Further, the processor 130 may control the communicator 110 to transmit a query request to the server device 200 from the electronic device 100. Herein, the processor 130 may control the communicator 110 to receive at least one keyword among the information related with a query request from the server device 200 according to a query request of the electronic device 100. The receiving a keyword of the electronic device 100 will be specifically explained below when explaining a controller 220 of the server device 200.

Further, when one keyword is selected from among at least one keyword through the inputter 120, the processor 130 may control the communicator 110 to request a relation information list regarding the selected keyword to the server device 200. Further, the processor 130 may control the communicator 110 to receive the relation information list regarding the selected keyword from the server device 200, and control the communicator 110 to request relation information regarding one information item among the received relation information list to the server device 200.

Further, the processor 130 may control the communicator 110 to receive a relation information result regarding the information item from the server device 200.

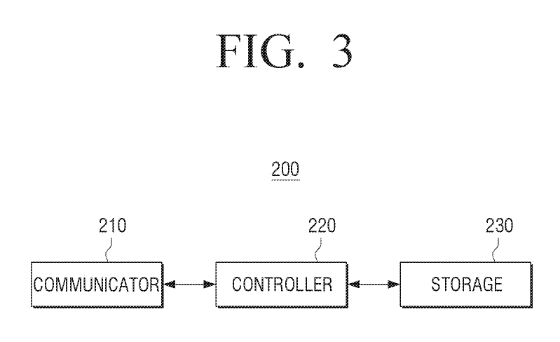

FIG. 3 is a block diagram illustrating constitution of the server device 200 according to an embodiment of the present disclosure.

Referring to FIG. 3, the server device 200 may include a communicator 210, a controller 220, a storage 230, and a memory (not illustrated).

The communicator 210 may receive a query request from the electronic device 100 by a user. Further, the communicator 210 may transmit the relation information related with a query request to the electronic device 100. Further, the communicator 210 may request data to the big data engine 300, and may be provided with the database from the big data engine 300.

The communicator 210 may be provided with data from the electronic device 100, the big data engine 300 and an open type data provider (not illustrated) through the network (not illustrated). The data may include data directly provided from the public or an individual person. The data may be data including metadata or schema.

The storage 230 may include computer-readable storage medium. According to an embodiment, the storage 230 may store data information which are collected/analyzed/stored by the controller 220 according to a query request of the electronic device 100. Further, the storage 230 may include programs implemented through the controller 220 or processes according to an embodiment. Further, the storage 230 may store data regarding the user interface used to display the result data on the electronic device 100.

The memory (not illustrated) may include a read-only memory (ROM), a flash memory, a dynamic random access memory (DRAM) such as synchronous DRAM (SDRAM), and a static memory (flash memory, static RAM (SRAM), and so on). The included memories may communicate with each other through a bus (not illustrated).

The processor (not illustrated) indicates one or more of general processors such as microprocessor or central processing unit. Specifically, the processor (not illustrated) may be a complex instruction set computing (CISC) microprocessor, a reduced instruction set computing (RISC) microprocessor, a very long instruction word (VLIW) microprocessor, a processor implementing another instruction set or processors implementing combination of instruction sets. The processor (not illustrated) may be one or more of specific-purpose processors such as application specific integrated circuit (ASIC), field-programmable gate array (FPGA), digital signal processor (DSP), and network processor. The processor (not illustrated) may be constituted to implement the controller 220 to perform operation and processes of the present disclosure.

The controller 220 may convert the feature information stored in the database into the data by using the semantic technology according to an embodiment. The semantic technology indicates the intelligence technology which sets up the languages and the rules that can be understood by a computer like that a person can read the screen and understand the meaning, which making the communication between computers to be performed possibly.

The technical essence of the semantic technology is to express data in the ontology format that can be processed by a computer. In the semantic technology, relation and concept information between entities belonging to corresponding environment may be expressed in the ontology format that can be processed by a machine, i.e., computer, and processed with an automatic machine.

The controller 220 may infer regarding a query received from the electronic device 100 based on the data stored in the database or the data within the ontology stored in the storage 230. Herein, the controller 220 may store the inferred result data in the storage 230, or update the data stored in the storage 230.

The ontology indicates a model that abstracts and shares how the people think of an object, which is a technology of standardizing and explicitly defining a type of a concept or a limited condition of use. The ontology is a data model expressing specific domain, and may be defined to be standard data indicating relations between a concept and a concept which belong to specific domain. The ontology may be a tool to implement the semantic technology and to connect data semantically. Further, the ontology may modify and process a concept of a thing owned by a human in a database format of a computer.

In the semantic technology, a triple or a schema format may be implemented as means for expressing relations. The triple indicates that a concept is expressed in a subject, predicate, and object format. Each of the subject, the predicate and the object may be expressed in the uniform resource identifier (URI) of extensible markup language (XML).

The schema triple of the ontology may be interpreted to express concepts of two entities, relations between the concepts, or features that can be owned by any concept. The triple of a schema level may express concepts of entities, meaning relations between the concepts, and plausible features.

Specifically, according to an embodiment, a user may express the data information using a designated music service of a designated smart phone with the schema triple of the ontology. A concept may be expressed in a user (subject)—use (predicate)—service (object) format. Further, a user may express the data information using a designated music service of a designated smart phone at a designated nation with the schema triple of the ontology. Herein, a concept may be expressed in a user (subject)—live (predicate)—nation (object) format. When a service (object) and a nation (object) additionally include lower objects (nodes), the two objects may be keywords automatically selected in the controller 220 according to an embodiment.

According to an embodiment, the controller 220 may control the communicator 210 to search information related with a query request of the electronic device 100 among the information stored in the storage 230 within the ontology, automatically select at least one keyword among the related information included in the ontology, and transmit at least one keyword to the electronic device 100 through the communicator 210.

As described above in FIG. 2, at least one keyword among the keywords automatically selected in the controller 220 may be displayed on the display 140 of the electronic device 100 through the user interface. Herein, a command may be inputted through the inputter 120 so as to select at least one keyword among the keywords displayed on the electronic device 100 by a user and request a related information list regarding the selected keyword.

When receiving a request of a related information list regarding the selected keyword among at least one keyword from the electronic device 100, the controller 220 may search information related with the selected keyword in the storage 230, categorize the searched information, and provide the result to the electronic device 100 through the communicator 210.

Herein, the categorization of the information may be performed by mapping the information regarding the database of the big data engine 300 and the database of the server device 200 with the related information included in the ontology of the server device 200. Herein, the generated mapping information may be stored in the storage 230. In the ontology triple format defined with the web ontology language (OWL) used according to an embodiment, the mapping can be easily understood by a person skilled in the art; specific explanation will not be described in this present disclosure.

Further, when receiving a request for related information regarding one information item among the categorized information from the electronic device 100, the controller 220 may additionally search information related with the information item in the storage 230, and provide the additionally searched information to the electronic device 100 through the communicator 210. Herein, according to an embodiment, the searching regarding information related with the information item may use the schema exploring. The schema exploring may variously classify database objects per type. Further, when a user selects an object, the schema exploring may show detailed items and data definition language (DDL) structure regarding the object based on the graphic.

Further, in order to obtain data information regarding the object selected in the electronic device 100, the controller 220 may convert a query request of the electronic device 100 into data of the big data engine 300 by using the mapping table stored in the storage 230. According to an embodiment, in the ontology defined with OWL, the controller 220 may finally convert the originally inputted simple protocol and resource description framework (RDF) query language (SPARQL) query sentence into a structured query language (SQL) query sentence by using the converted data. The controller 220 may obtain the result data regarding a query request by delivering the converted SQL query sentence to the big data engine 300.

Thus, according to an embodiment, the controller 220 may generate related information between data objects by using the semantic technology. The controller 220 may generate a related information list by using the ontology based on the generated related information. Herein, when the electronic device 100 selects an object, the controller 220 may show detailed items or DDL structure regarding the object based on the graphic by using the schema exploring. Through the above process, a user using the electronic device 100 may explore and access big data by selecting information regarding the requested data more easily without having any professional knowledge of the selected object.

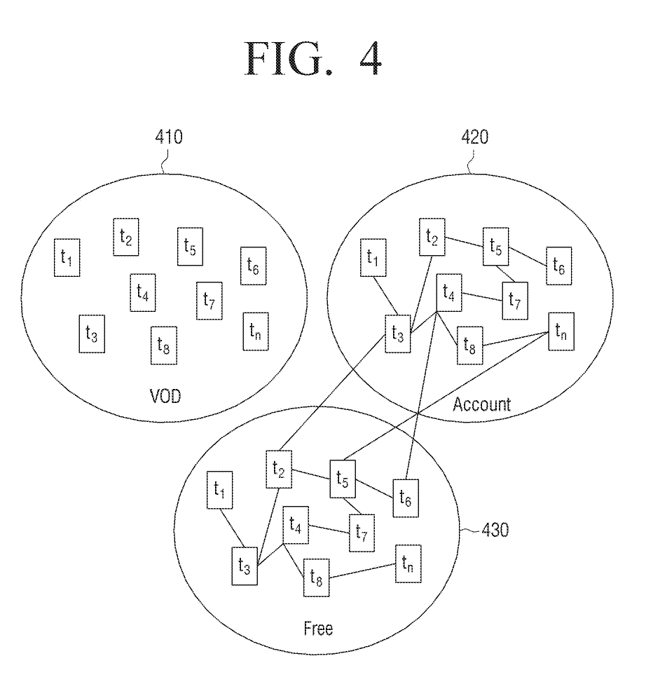

FIG. 4 is a diagram illustrating the ontology concept regarding a query request according to an embodiment of the present disclosure. FIG. 4 illustrates a database 410 of the related art simply categorizing related information of data and databases 420, 430 categorizing each database within a specific domain by using the ontology according to an embodiment.

For example, FIG. 4 illustrates the database of the big data regarding an account management service “Account” database 420, a video on demand (VOD) service “VOD” database 410, and a free music service “Free” database 430, which are used in a smart phone (e.g., electronic device 100) by a user. Herein, within the domain of VOD database 410 service and the specific domain of the free music database 420 service, the data may be categorized. However, a service name and a type of the electronic device are merely one of embodiments for explanation of the present disclosure; it may be implemented with various methods.

Specifically, regarding the data included in VOD database 410, various data lists such as contents t1, user information t2, and types of contents t3, t4 may be included in the database. Further, regarding the data included in the free music database 430, various data lists such as contents t1, user device information t2, and names of device models t3 may be included in the database. Further, regarding the data included in the account management database 420, various data lists such as user identification (ID) information t1, and user device information t2 may be included in the database.

Referring to FIG. 4, the data of databases 420, 430 included within the ontology of the data using the semantic technology may generate related information lists correlating with each other by confirming the related information between data lists of one domain and another domain as well as between data lists of each domain. Therefore, even when a user does not have a professional knowledge regarding the categorized data within specific domain, a user may easily access and understand the requested data by categorizing relations of the information correlated between the information included in the ontology.

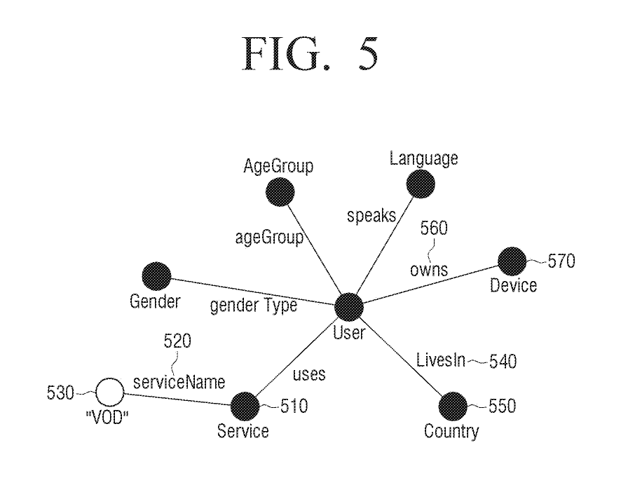

FIG. 5 is a diagram illustrating the ontology schema structure regarding a query request according to an embodiment of the present disclosure.

Referring to FIG. 5, words becoming each subject and object may be nodes 510, 530, 550, 570 of the ontology, and predicates expressing a relation between the two nodes may be branches 520, 540, 560.

As described in the controller 220 of FIG. 3, the schema triple of the ontology may be interpreted to express concepts of two entities, relations between the concepts or the feature that can be obtained by any concept. The triple of the schema level may express concepts of entities, meaningful relations between the concepts, and plausible features. Specifically, a concept may be expressed in a user (subject)—use (predicate)—service (object) format.

Referring to FIG. 5, user, country, device, language, agegroup, gender and VOD service may be subjects in the triple structure of the schema level and concepts of entities. Owns, speaks, gender type, servicename, and uses may be predicates in the triple structure of the schema level and express meaningful relations between entities and concepts. Herein, the service node 510 which is both subject and object may be a keyword automatically selected in the server device 200 according to an embodiment.

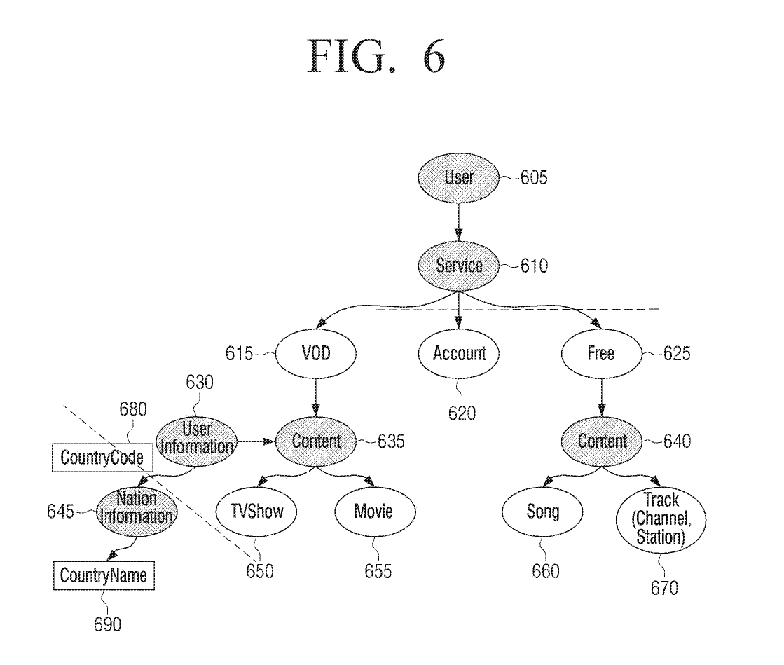

FIG. 6 is a diagram explaining the ontology when schema-exploring regarding a query request according to an embodiment of the present disclosure. FIG. 6 illustrates the schema exploring constituted with nodes excluding predicates in the triple structure of the ontology illustrated in FIG. 5.

Referring to FIG. 6, a process may be explained in which a user accesses a designated music application in a mobile terminal (e.g., smart phone, tablet PC, portable terminal), and explores big data information regarding the used contents.

Specifically, the ontology may include the information of a service 610 used by a user 605. The service 610 may include the information regarding an account management service 620, a VOD service 615, and a free music service 625. Therefore, when a big data user searches the information regarding the service 610 used by the user 605 in the big data, the server device 200 may explore the relation information of VOD service 615, account management service 620, and free music service 625 related with the service 610 included in the ontology and generate a relation list.

Further, the server device 200 may generate a relation list of user information 630 related with VOD service 615 and the free music service 625 included in the ontology, nation information 645 related with the user information 630, and contents 635, 640. Further, a relation list of contents information 650, 655, 660, 670 related with the contents 635, 640 may be generated.

Thus, regarding a query request of the electronic device 100, a varied and expanded related information list may be generated by connecting the related data information (nodes) among the information included in the ontology. Herein, among the nodes included in the domain, the nodes becoming subjects and objects in the triple structure of the ontology may be automatically selected as keywords by the server device 200, and the selected keywords may be displayed on the electronic device 100. Specifically, the service 610, the user information 630, and the content 635 may be selected as keywords by the server device 200. Further, the generated related information list and keyword information may be stored in the server device 200, which updating the database of the server device 200.

Further, according to an embodiment, the server device 200 may convert the code values defined when mapping the data information within the ontology and the information of the database into a language that can be easily understood by a user. For example, when a node within the ontology indicates nation information of the user, a related technology defines a countrycode 680 which is difficult to be understood by a normal user in the related information list. However, according to an embodiment, the nation information of the user may be converted into a countryname 690. According to another embodiment, for example, when a node within the ontology indicates a name of a device used by the user, a related technology defines deviceID (not illustrated). However, according to an embodiment, a name of a device may be converted into a devicename (not illustrated), which may be implemented to be a word that can be easily understood by the user. That is, a code stored in a mapping table may be converted into a value, and converted into a language that can be easily understood by a normal user.

Further, according to another embodiment, the server device 200 may generate the cross related information between the ontologies of specific domain and another specific domain, and thus, generate more expanded related data. For example, when the content 635 viewed by the user 605 using VOD service 615 is the movie content information 655, the server device 200 may generate original title information (not illustrated) of the movie content information 655 to be relation information, or generate a related movie title (not illustrated) from the original title information (not illustrated). Further, a movie music may be suggested to a big data user by generating a related information list with the related movie title (not illustrated) and the related movie music (not illustrated).

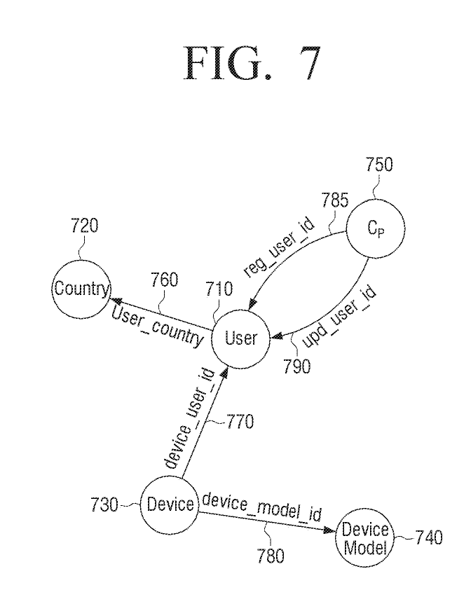

FIG. 7 is a diagram explaining a method of exploring within the ontology regarding a query request according to an embodiment of the present disclosure.

Referring to FIG. 7, the ontology may be constituted with a source node 710 (i.e., “User”) and designation nodes 720, 730, 740, 750. When a query request of the electronic device 100 is received, the server device 200 may search information related with a query request in the information included in the ontology, and generate a related information list related with a query request. Herein, in order to generate related information within the ontology, the source node 710 may repeatedly visit branches 760, 770, 780, 785, 790 until a designation node is spotted.

Specifically, when a start node is Cp designation node 750 which is a contents provider and a designation node is a device model designation node 740, an embodiment of a program processing until the start Cp designation node 750 finds the device model designation node 740 is as follows.

1. Paths={ }
2. Start from Cp; find all neighbors
   a. Cp-User
   b. For each neighbor;
      i. if(neighbor=end node), update paths, stop; paths={ }
      ii. if(neighbor=end node) go to 3
3. From each neighbor from 2; find all neighbors
   a. Cp-User-Device
   b. Cp-User-Country
   c. for each neighbor;
      i. if(neighbor=start node), discard neighbor
      ii. if(neighbor=end node), update paths, stop; paths={ }
      iii. if(neighbor=end node) go to 4
4. From each neighbor from 3, find all neighbors
   a. Cp-User-Device-DeviceModel
   b. for each neighbor;
      i. if(neighbor=start node), discard neighbor
      ii. if(neighbor=end node), update paths, stop;
         paths={Cp-User-Device-DeviceModel}

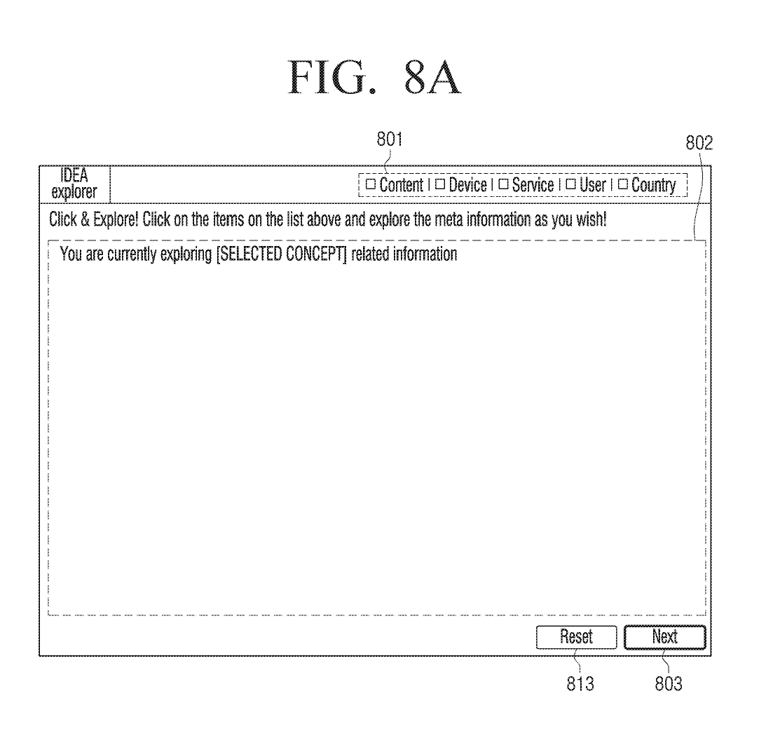

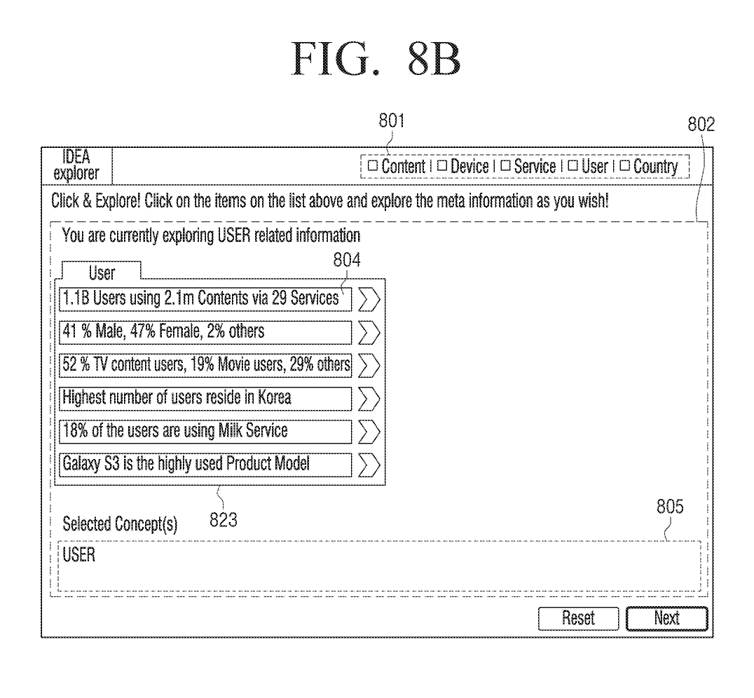

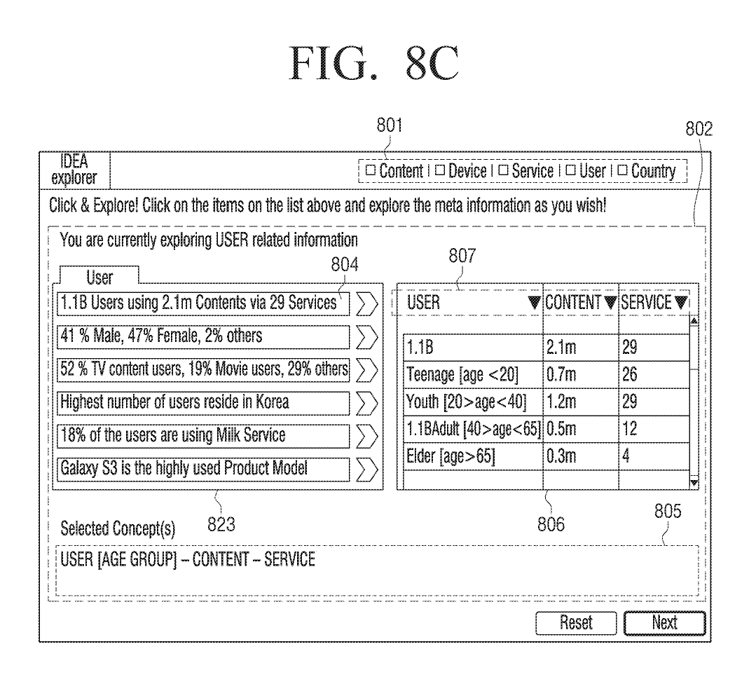

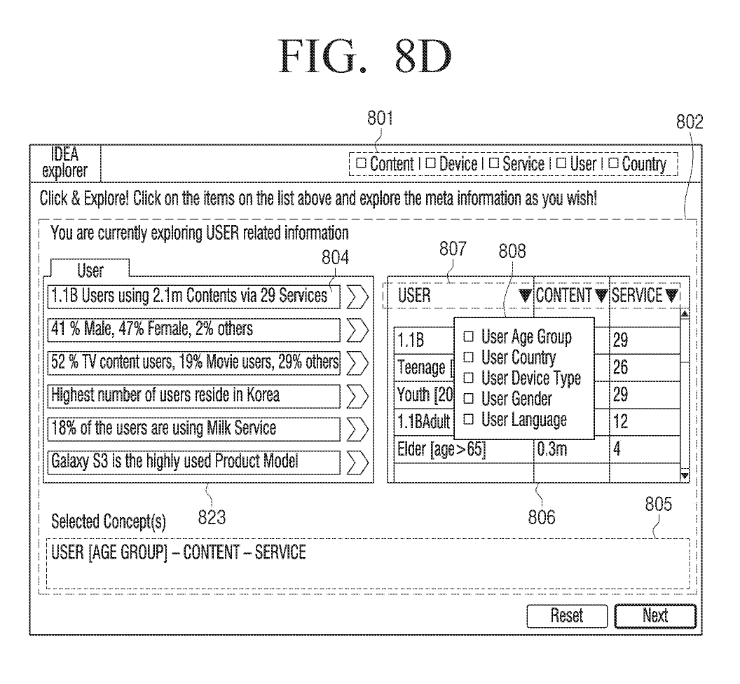

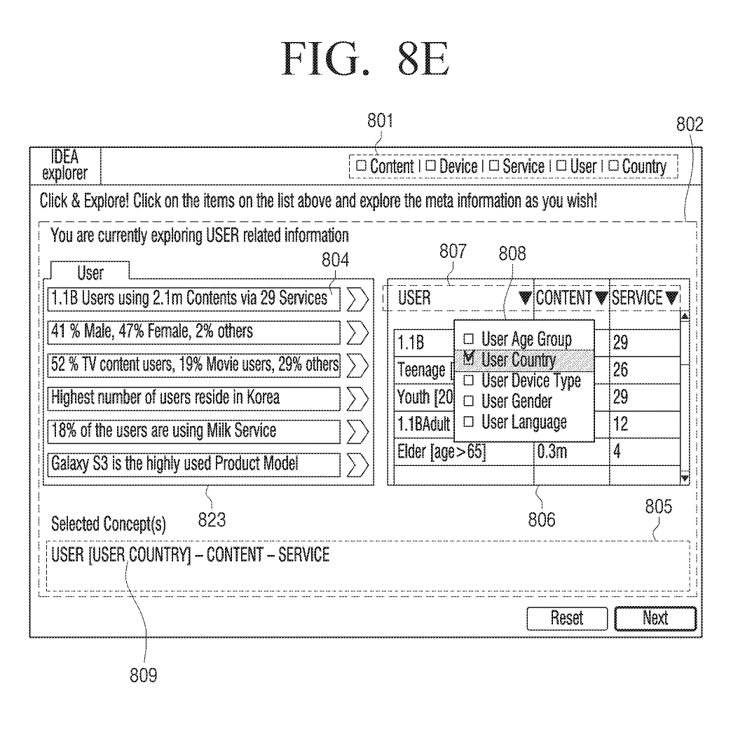

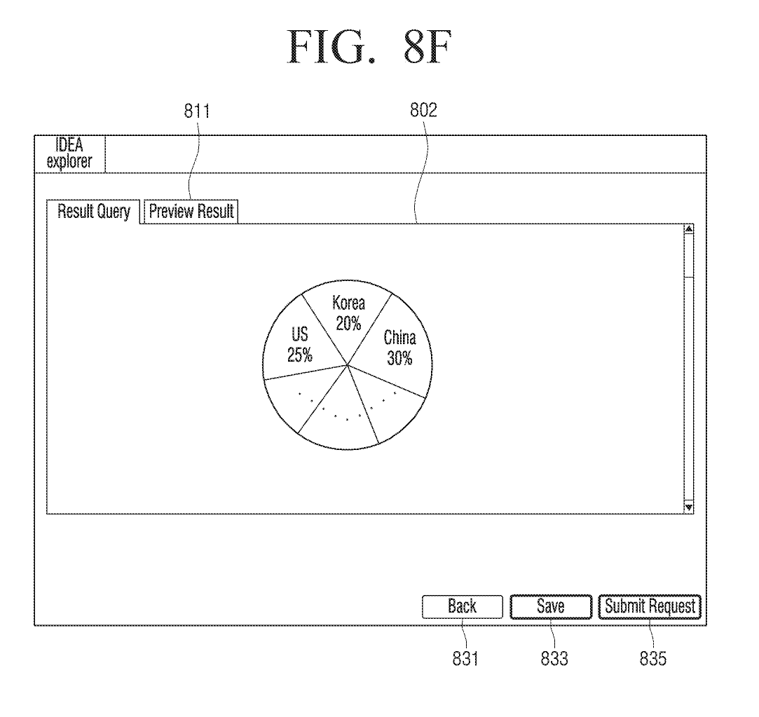

Further, a process of generating a related information list by the server device 200 regarding a query request of the electronic device 100 will be described by referring to FIGS. 8A to 8F. For example, when paths are selected as Cp designation node 750—User source node 710—Device designation node 730—Device Model designation node 740 in the server device 200, path segment branches 770, 780, 785, 790 of each selected path may generate the ontology schema triple, and join in each triple pattern. Herein, an embodiment of a query generation program is as follows.

SELECT CP_ID ?DEVICE_MODEL_ID

```
  WHERE {
  {
```

{ ?CP_ID rdf:type sg:Cp .

```
  ?CP_ID sg:reg_use_id ?USER_ID .}
UNION
{ ?CP_ID sg:upd_user_id ?USER_ID .}
  }
  ?DEVICE_ID sg:dvice_user_id ?USER_ID .
  ?DEVICE_ID sg:dvice_model_id ?DEVICE_MODEL_ID .
  }
```

FIGS. 8A to 8F are diagrams explaining that a schema exploring result within the ontology is displayed on the electronic device according to an embodiment of the present disclosure. However, FIGS. 8A to 8F are merely one embodiment for explanation of the present disclosure; display screen and constitution through the user interface may be implemented or modified with various methods.

Referring to FIG. 8A, a user may select at least one among keyword items 801 displayed on the electronic device 100 and received from the server device 200. Referring to a section of the schema ontology of FIG. 6, in FIG. 8A, the keyword items 801 such as content, device, service, user, and country displayed on the electronic device 100 may be nodes controlling lower nodes in the strata structure of the nodes within the ontology of the server device 200. Further, the keywords may be nodes which are subjects and objects in the triple structure of the ontology.

When a user selects at least one among the keyword items 801, the relation information related with the selected keyword and the summary information of the selected keyword may be displayed on a display screen 802 which is an information area of the electronic device 100. A user may click a “Next” button 803 and confirm a next page, or click a “Reset” button 813 and reset the screen to be defaulted.

FIG. 8B is a diagram illustrating the relation information list related with a user displayed on the display screen 802 when a user selects user among the keywords according to an embodiment. Referring to FIG. 8B, a detailed related information list 823 regarding a user using a designated service may be displayed.

Specifically, as illustrated in FIG. 8B, when a user selects “User” among the keyword items 801 in the electronic device 100, the electronic device 100 may display the selected keyword on a selected concept screen 805. According to an embodiment, a default value of the selected keyword item 801 may be established to be “USER”; however, this is merely one embodiment, and it may be implemented with various methods.

Further, the electronic device 100 may display the detailed related information list 823 which is categorized regarding the selected keyword. Herein, when a user requests more detailed information of the detailed related information list 823, an item 804 may be selected from among the displayed detailed related information list 823. For example, information of the detailed related information list 823 illustrated in FIG. 8B may show that 1.1 billion users use 2.1 million of contents at 29 services. Further, the user information may show 41% of the male, 47% of the female and 2% of the others.

Thereafter, when a user selects an item among the information list selected in FIG. 8B, detailed information regarding the selected item may be displayed as illustrated in FIG. 8C. Referring to FIG. 8C, when the selected item 804 is user information using contents through a service, the electronic device 100 may display a detailed information list 806 regarding the selected item 804 of the detailed related information list 823.

The electronic device 100 may mark “USER,” “CONTENT,” and “SERVICE” which are related keywords (concepts) 807 within the selected item 804 of the detailed related information list 823 on a table, summarize and display detailed information regarding each keyword. Further, the electronic device 100 may display the related keywords 807 of the detailed information list 806 on the selected concept screen 805. Although a default value of the selected keywords 807, “USER,” is established to be “AGE GROUP” for explanation of the present disclosure, this is merely one of embodiments. The default value may be implemented with various methods.

Referring to FIG. 8D, when a user selects “USER” of the related keywords 807, the electronic device 100 may display a detailed relation information list 808 related with the user information which are “User Age Group,” “User Country,” “User Device Type,” “User Gender,” and “User Language.” Although a default value of the selected keywords 807, “USER,” is established to be “AGE GROUP” for explanation of the present disclosure, this is merely one of embodiments. The default value may be implemented with various methods.

Referring to FIG. 8E, a user may select “USER” of the related keywords 807, and select “User Country” among the detailed relation information list 808. Herein, a keyword of the selected keywords 807, “USER,” is converted from a default value, “AGE GROUP,” into “USER COUNTRY,” 809, as reflected in FIGS. 8D and 8E. When a user confirms a result regarding the data of “User Country” selected on the detailed relation information list 808, he may request a result of the related data or a preview to the server device 200 by selecting the “Next” button 803.

Referring to FIG. 8F, when a user selects to confirm the result data regarding “User Country” in FIG. 8E through the electronic device 100, a result such as a graph or chart or an index (not illustrated) regarding the related data may be displayed on the display screen 802 which is information area.

Further, when a user requests a preview of the result data regarding a query request to the server device 200 by selecting a preview result tab 811, a preview result (not illustrated) regarding the result data may be displayed on the display screen 802. Further, a user may save (“Save”) the result of the data extracted by the server device 200, submit a request (“Submit Request”), or go back (“Back”) to the previous screen and select another related data by selecting one among “Back,” 831 “Save,” 833 and “Submit Request” 835.

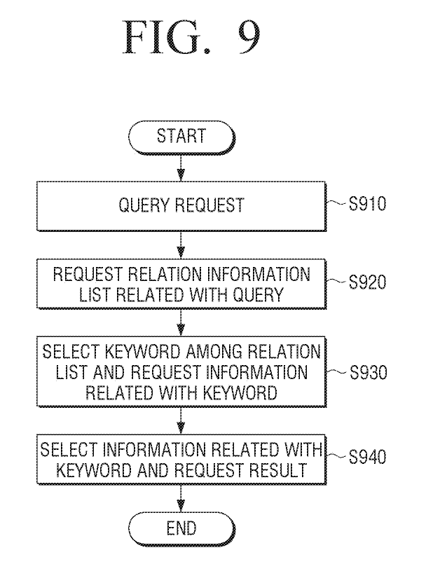

FIG. 9 is a flowchart explaining a process of requesting a query to the server device 200 by the electronic device 100 according to an embodiment of the present disclosure.

Referring to FIG. 9, a user may request a query to the server device 200 by inputting requested data information to the electronic device 100 at operation S910. Herein, the data information inputted to the electronic device 100 may be a query request which is inputted by a user according to the inputting means such as keyboard, touch, mouse, and stylus pen. Further, the data information inputted to the electronic device 100 may be one of the information lists displayed on the electronic device 100 so that a user can select one among the related information provided to the electronic device 100.

Further, the electronic device 100 may request a related information list related with a query to the server device at operation S920. Herein, the electronic device 100 may receive the keywords automatically selected within the ontology by the server device 200 and the related information list related with the keywords from the server device 200, among the relation information related with a query request searched in the server device 200 by using the semantic technology.

The electronic device 100 may select at least one among the keywords received in the server device 200, and request relation information related with the selected keyword at operation S930. Herein, the electronic device 100 may receive the detailed related information list related with the selected keyword by the electronic device 100 from the server device 200. Further, the electronic device 100 may select at least one among the detailed related information lists related with the keywords received from the server device 200. Herein, the electronic device 100 may select the information related with the keyword requested by a user, and request a result regarding the information related with the selected keyword to the server device 200 at operation S940. Herein, the electronic device 100 may be provided with a data result from the server device 200 through the user interface such as chart, index, and graph.

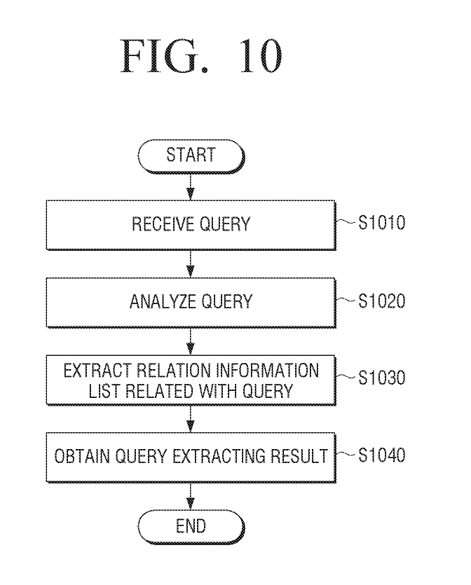

FIG. 10 is a flowchart explaining a process in which the server device explores and accesses the big data regarding the query request received from the electronic device according to an embodiment of the present disclosure.

Referring to FIG. 10, the server device 200 may receive a query request from the electronic device 100 at operation S1010.

The server device 200 may analyze a query regarding the received query request from the electronic device at operation S1020. Herein, the server device 200 may collect data related with a query from the internal database and the external database through the network. Further, based on the collected information, the server device 200 may generate a relation list related with a query by using the semantic technology and transmit the generated relation list to the electronic device 100 according to an embodiment.

Further, the server device 200 may extract a relation information list related with a query at operation S1030. Herein, the server device 200 may automatically select a keyword among the objects related with a query included in the ontology of the relation list generated by using the semantic technology, and transmit to the electronic device 100. According to an embodiment, the keyword selected by the server device 200 may be a subject and an object in the ontology triple expression, or may be an upper node controlling a lower node in the ontology structure constituted with the nodes and the branches. Further, the server device 200 may transmit the related information list extracted by using the infer method of the ontology triple expression to the electronic device 100.

Further, when the server device 200 additionally searches a detailed related information list regarding at least one among the related information lists selected by the electronic device 100, the schema exploring may be used within the ontology using the semantic technology. The server device 200 may show the detailed items or DDL structure regarding the related information list related with a query based on the graphics through the schema exploring.

Further, the server device 200 may receive a result request and a preview request regarding the related information list selected by the electronic device 100. Herein, the server device 200 may convert the originally inputted query from SPARQL to SQL so that the big data engine 300 can search a query request, request and obtain the data related with the big data engine 300. Thereby, the server device 200 may obtain a query extracting result regarding the query requested from the electronic device 100 at operation S1040.

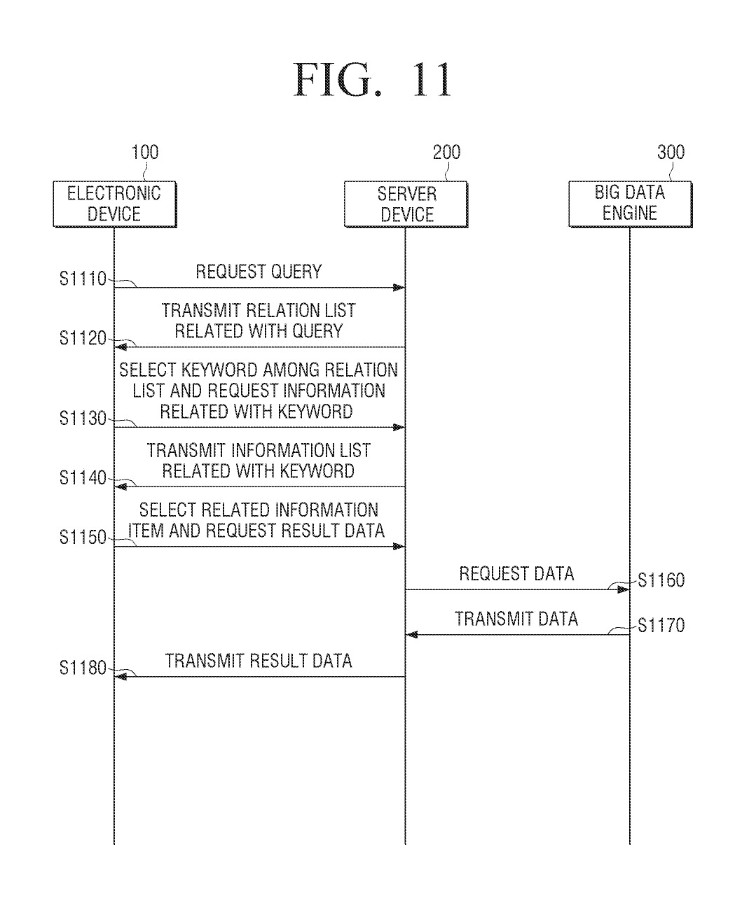

FIG. 11 is a sequence diagram explaining a process in which the electronic device and the server device explore and access the data from the big data engine according to an embodiment of the present disclosure.

Referring to FIG. 11, the electronic device 100 may request a query to the server device at operation S1110. The server device 200 may transmit the relation list regarding the query to the electronic device 100 at operation S1120. The electronic device 100 may select a keyword among the relation list received from the server device 200, and request information related with the selected keyword to the server device at operation S1130. The server device 200 may transmit the information list related with the keyword received from the electronic device 100 to the electronic device 100 at operation S1140. The electronic device 100 may select at least one related information item among the received information list from the server device, and request result data regarding the selected item at operation S1150. Herein, the server device 200 may request data related with the result data to the big data engine 300 at operation S1160. The big data engine 300 may transmit the data requested by the server device 200 at operation S1170. The server device 200 may transmit the data result received from the big data engine 300 to the electronic device 100 at operation S1180.

Therefore, according to the embodiments, the server device 200 may analyze the query request by using the semantic technology and the ontology regarding the query request received from the electronic device 100, categorize the information related with the query request, and provide the result to the electronic device 100. Thereby, a user can easily search and access necessary information without professional knowledge regarding the related information stored in the big data engine. As a result, according to an embodiment, the efficiency in accessing and analyzing of the big data exploring can be enhanced.

The control method according to an embodiment may be implemented within storage medium that can be read with a computer or a similar device by using software, hardware, or a combination thereof.

The device and the method according to the various embodiments may be, for example, performed with at least one computer (e.g., processor) implementing instructions included in at least one program among the programs maintained in the computer readable storage medium.

When the instructions are implemented with a computer (e.g., processor), at least one computer may perform corresponding function to the instructions. Herein, the computer readable storage medium may be a memory, for example.

The programs may be, for example, included in the computer readable storage medium such as hard disc, floppy disc, magnetic media (e.g., magnetic tape), optical media (e.g., compact disc ROM (CD-ROM), digital versatile disc (DVD)), magneto-optical media (e.g., floptical disc), and hardware device (e.g., ROM, RAM, flash memory). In this case, the storage medium may be generally included as a part of the electronic device; however, it may be equipped through a port of the electronic device, or included in an external device (e.g., cloud, server or another electronic device) positioned externally of the electronic device.

Further, the programs may be divided and stored in a plurality of the storage media. Herein, at least a part among a plurality of the storage media may be positioned on an external device of the electronic device.

The instructions may include the high class language code that can be run with a computer by using an interpreter as well as mechanical code generated with a compiler. The above described hardware device may be constituted to operate as more than one software module in order to perform the operation according to the various embodiments, or vice versa.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A server device comprising:
a communicator configured to receive a query request from an external electronic device;
a storage configured to store information related with a query of the query request; and
at least one processor configured to:
search for relation information related with the query of the query request based on the query request within an ontology which is generated by using data stored in a database,
generate a relation information list based on the data included in the ontology,
automatically select at least one keyword in the relation information list, and
control the communicator to transmit the selected at least one keyword to the external electronic device.

2. The server device of claim 1, wherein, when a related information list request regarding the selected at least one keyword is received from the external electronic device, the at least one processor is further configured to:
search the storage for information related with the selected keyword,
categorize the searched information related with the selected keyword, and
control the communicator to transmit a result to the external electronic device.

3. The server device of claim 2, wherein, when a related information request regarding one information item among the categorized information is received from the external electronic device, the at least one processor is further configured to:
additionally search the storage for information related with the information item, and
control the communicator to transmit the additionally searched information to the external electronic device.

4. The server device of claim 3, wherein, when a result request regarding one information item among the additionally searched information is received from the external electronic device, the at least one processor is further configured to:
extract the information related with the information item in the database, and
control the communicator to transmit the extracted related information to the external electronic device.

5. The server device of claim 1,
wherein the ontology is configured with a plurality of entity nodes having concepts and relation branches connecting the plurality of entity nodes, and
wherein the at least one processor is further configured to automatically select a concept of at least one of the entity nodes as the keyword when the at least one entity node comprises an entity node lower than remaining entity nodes of the plurality of entity nodes.

6. The server device of claim 1, wherein the at least one processor is further configured to:
map data in the database into a plurality of entity nodes of the ontology,
convert a code value defined when mapping the data within the ontology into general words, and
generate the relation information list using the general words.

7. An electronic device comprising:
a communicator configured to receive information related with a query request from a server device;
an inputter configured to receive a user command regarding the query request from a user and the information related with the query request received from the server device;
a display; and
at least one processor configured to control the display to display information related with the query request received from the server device through the communicator.

8. The electronic device of claim 7, wherein the at least one processor is further configured to:
control the communicator to transmit the query request to the server device,
control the communicator to receive at least one keyword among the information related with a query of the query request from the server device according to the query request, and
control the communicator to request a related information list regarding the received at least one keyword to the server device, when an item is selected through the inputter from among the at least one keyword.

9. The electronic device of claim 8, wherein the at least one processor is further configured to:
control the communicator to receive the related information list from the server device,
control the communicator to request related information regarding an information item among the received related information list to the server device, and
control the communicator to receive a related information result regarding the information item from the server device.

10. A data processing method of a server device, the data processing method comprising:
receiving a query request from an external electronic device;
storing information related with a query of the query request;
searching for relation information related with the query of the query request based on the query request within an ontology which is generated by using data stored in a database;
generating a relation information list based on the data included in the ontology;
automatically selecting at least one keyword in the relation information list; and
transmitting the selected keyword to the external electronic device.

11. The data processing method of claim 10, wherein, when a related information list request regarding the selected at least one keyword is received from the external electronic device, the method further comprises:
searching for information related with the selected at least one keyword;
categorizing the searched information; and
transmitting a result to the external electronic device.

12. The data processing method of claim 11, wherein, when a related information request regarding an information item among the categorized information is received from the external electronic device, the method further comprises:
additionally searching for information related with the information item; and
transmitting the additionally searched information to the external electronic device.

13. The data processing method of claim 12, wherein, when a result request regarding an information item among the additionally searched information is received from the external electronic device, the method further comprises:
extracting information related with the information item in the database; and
transmitting the extracted related information to the external electronic device.

14. The data processing method of claim 10,
wherein the ontology is configured with a plurality of entity nodes having concepts and relation branches connecting the plurality of entity nodes, and
wherein the transmitting comprises automatically selecting a concept of an entity node as the keyword when the entity node comprises an entity node lower than remaining entity nodes of the plurality of entity nodes.

15. The data processing method of claim 10, wherein the method further comprises:
mapping the data stored in the database into a plurality of entity nodes of the ontology,
converting a code value defined when mapping the data within the ontology into general words, and
generating the relation information list using the general words.
